(19) United States
(12) Patent Application Publication
(10) Pub. No.: US 2013/0124371 A1
(43) Pub. Date: May 16, 2013

(54) DETERMINING LOCAL CATALOG OF DIGITAL CONTENT

(71) Applicants: Japan Mehta, Coppell, TX (US); Shafiq Kassam, Lewisville, TX (US)

(72) Inventors: Japan Mehta, Coppell, TX (US); Shafiq Kassam, Lewisville, TX (US)

(73) Assignee: Verizon Patent and Licensing Inc., Basking Ridge, NJ (US)

(21) Appl. No.: 13/296,263

(22) Filed: Nov. 15, 2011

(51) Int. Cl. G06F 15/16; G06Q 30/00

(52) U.S. Cl. 705/27.1; 709/217

(57) ABSTRACT

A method includes receiving local digital content consumption information associated with a location. The method also includes identifying a local consumption pattern for digital content based on the local digital content consumption information. The method further includes receiving a global catalog of digital content. A local catalog of digital content is determined based on the local consumption pattern for digital content and the global catalog of digital content. The method also includes providing the local catalog of digital content using a local area network.

### BACKGROUND INFORMATION

Content providers currently provide many types of digital content, such as movies, television episodes, video games, music, applications, etc. The digital content may be provided to consumers on a purchase or rental basis. Digital rights management, associated with the digital content may limit access time, transfer capabilities or other rights associated with the digital content.

### BRIEF DESCRIPTION OF THE DRAWINGS

FIG. 1 illustrates an exemplary network in which systems and methods described herein may be implemented;

FIG. 2A illustrates another exemplary network in which systems and methods described herein may be implemented;

FIG. 2B is a diagram of an overview of an exemplary embodiment of a location based digital content message on a user device;

FIG. 2C illustrates another exemplary network in which systems and methods described herein may be implemented;

FIG. 3 illustrates an exemplary configuration of one or more of the components of FIGS. 1-2C;

FIG. 4 is a flowchart of an exemplary process for identifying digital content to be provided at a location; and

FIG. 5 is a flowchart of an exemplary process for providing location based digital content to a user device.

### DETAILED DESCRIPTION OF PREFERRED EMBODIMENTS

The following detailed description refers to the accompanying drawings. The same reference numbers in different drawings may identify the same or similar elements. Also, the following detailed description is exemplary and explanatory only and is not restrictive of the invention, as claimed.

Embodiments described herein relate to devices, methods, and systems for determining a local catalog of digital content to be provided at a location. The local catalog of digital content may be determined based on a global catalog of digital content and a pattern of digital content consumption associated with the location. Consistent with the embodiments described herein, a digital content provider may provide content from the local catalog of digital content to user devices using a local area network. Also, a digital content provider may cache digital content, based on the local catalog of digital content, to be provided to user devices or provider devices.

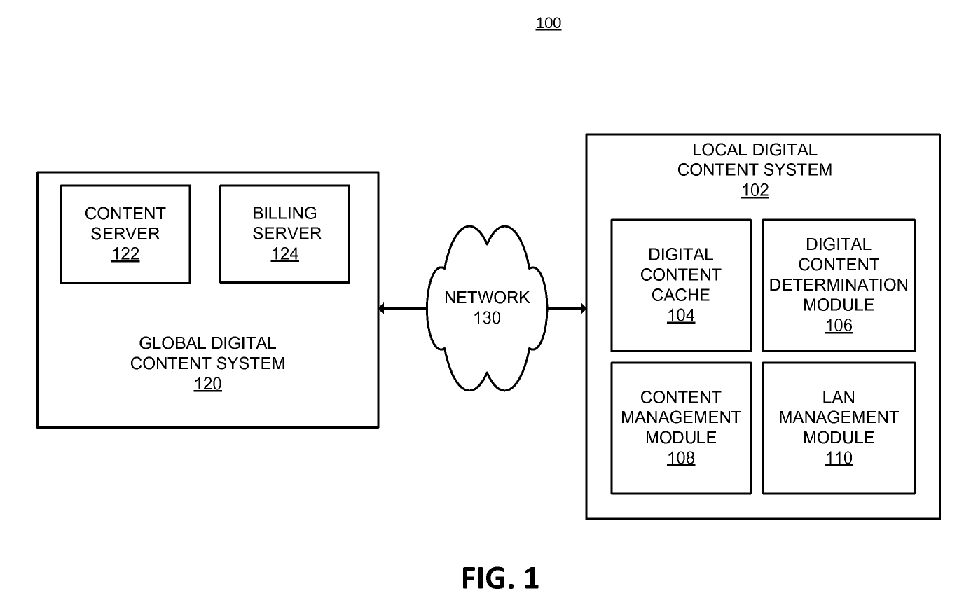

FIG. 1 is a diagram of an exemplary network 100 in which systems and/or methods described herein may be implemented. As illustrated, network 100 may include a local digital content system 102 and a global digital content system 120. Local digital content system 102 may include a digital content cache 104, a content management module 108, a digital content determination module 106, and a local area network (LAN) management module 110. Global digital content system 120 may include a content server 122 and a billing server 124. Local digital content system 102 and global digital content system 120 may be interconnected by network 130. Components of network 100 may be interconnected via wired and/or wireless connections.

The configuration of components of network 100 illustrated in FIG. 1 is for illustrative purposes. Although not shown, network 100 may also include other components of a network for a digital content provider, such as customer information servers, security devices, etc. Other configurations may be implemented. Therefore, network 100 may include additional, fewer and/or different components than those depicted in FIG. 1. Also, in some instances, one or more of the components of network 100 may perform one or more functions described as being performed by another one or more of the components of network 100.

Network 100 may be implemented to determine a local catalog of digital content to be provided at a location. The local catalog of digital content may be determined based on a global catalog of digital content and a local pattern of digital content consumption. The digital content may include movies, applications, music, etc. The global catalog of digital content may be provided by global digital content system 120. The global catalog of digital content may include a listing of digital content that may be provided by global digital content system 120 (i.e., entries in the global catalog of digital content). The local catalog of digital may include a listing of digital content that may be provided by local digital content system 102.

Network 130 may include one or more wired and/or wireless networks that are capable of receiving and transmitting data, voice and/or video signals, including multimedia signals that include voice, data and video information. Network 130 may include one or more wireless / mobile networks and/or a public switched telephone network (PSTN). Network 130 may include one or more packet switched networks, such as an Internet protocol (IP) based network, a LAN, a wide area network (WAN), a personal area network (PAN), an intranet, the Internet, or another type of network that is capable of transmitting data. Network 130 may include one or more high-speed data networks, such as a very high performance backbone network services (vBNS) network.

Global digital content system 120 may provide digital content for subsystems or devices within network 100, such as local content system 102. Global digital content system 120 may be implemented as a “stand alone” system to provide the digital content. Alternatively, global digital content system 120 may be implemented in a head end (i.e., master facility) for a telecommunications provider (e.g., in a central office for a telecommunications provider) in conjunction with other systems (not shown) to support an integrated suite of products and services (e.g., telecommunications services, such as cable, Internet, mobile telephone service, etc., combined with digital content offerings).

Content server 122 may maintain a database of stored digital content corresponding to the global catalog of digital content and provide a subset of the digital content for local content system 102 based on input received from administrators and/or local content system 102. For example, an administrator may upload particular digital content through content server 122 to local digital content system 102 based on information associated with the digital content (e.g., a release date, rating, genre, etc., of a movie). Alternatively, content server 122 may receive requests for particular digital content from local digital content system 102. Content server 122 may also require various security and login parameters to permit access to, and transfer of, digital content.

Billing server 124 may provide support for consumer transactions, such as purchase or rental of digital content, including determining billing information for customers that purchase or rent the digital content. For example, billing server 124 may identify a customer account associated with a user device and/or may communicate with an external billing system (e.g., a credit card company account system) to verify and execute transactions.

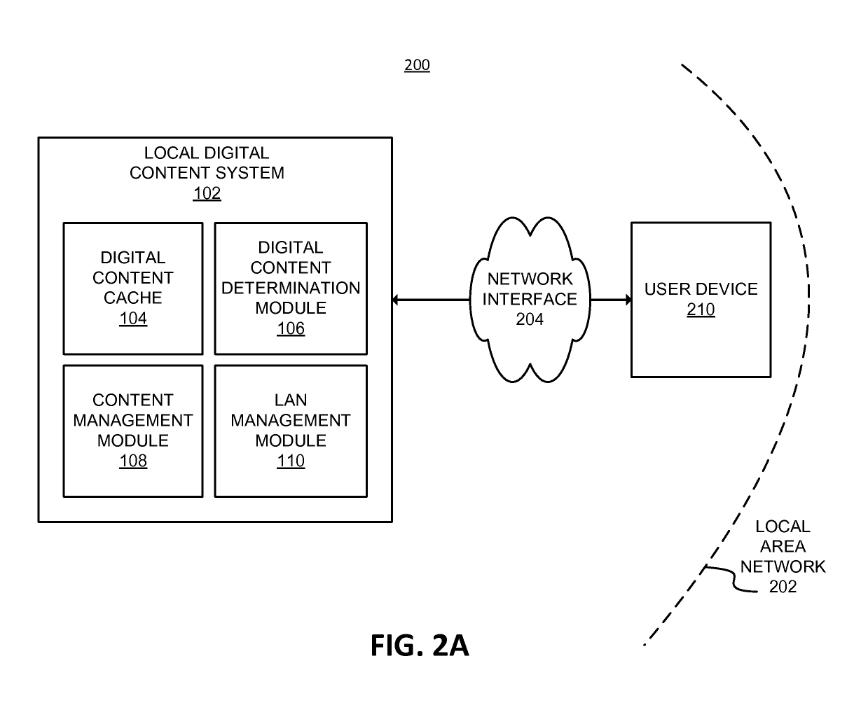

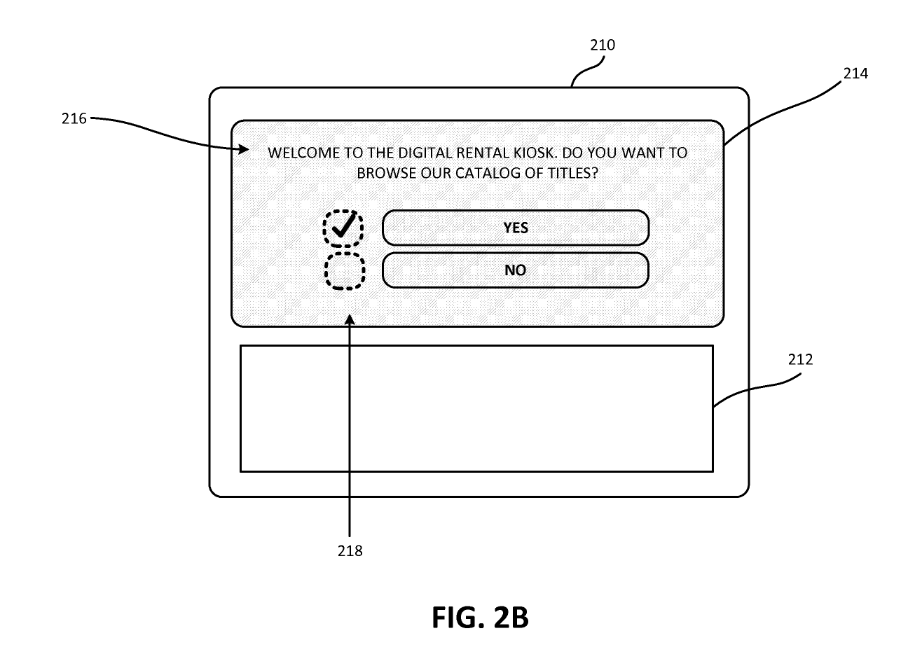

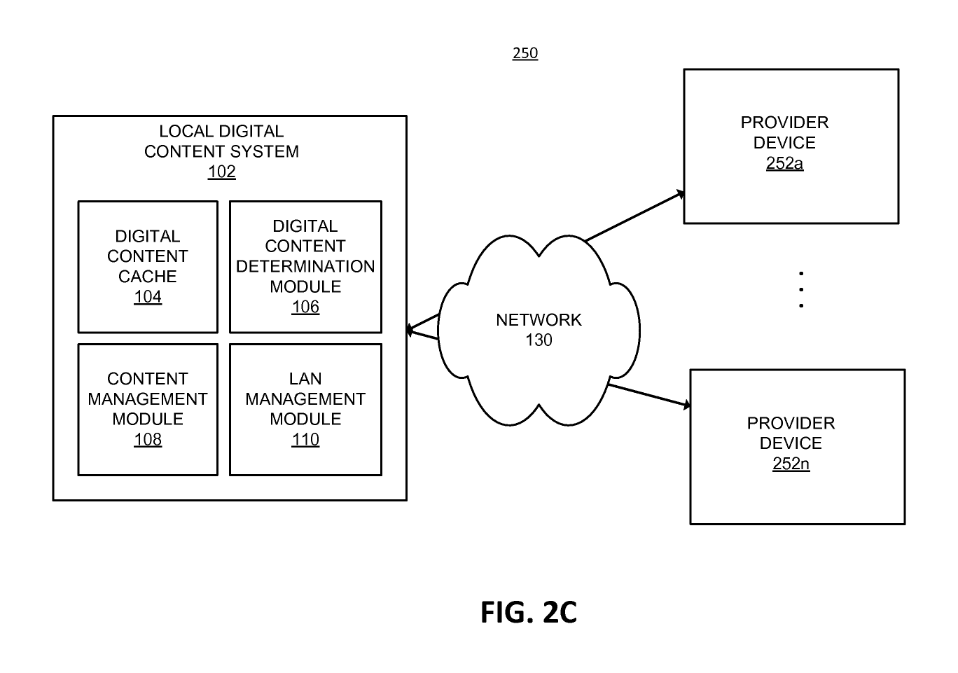

Local digital content system 102 may determine and maintain a local catalog of digital content based on a local consumption pattern for digital content and the global catalog of digital content. The local consumption pattern may be determined based on the digital content browsed, rented, purchased, transferred or accessed at a location, such as a LAN in network 100 at which the digital content is provided, for instance as described below with respect to FIG. 2A or FIG. 2C. The global catalog of digital content may be received from global digital content system 120. Local digital content system 102 may provide content corresponding to entries in the local catalog of digital content to user devices and provider devices. The provider devices may include network routing devices and retail interface devices. A network routing device may cache and distribute content, for example as described with respect to FIG. 2C below. A retail interface device may perform similar functions as described with respect to local digital content system 102 and FIG. 2A below.

Digital content cache 104 may include digital content listed in the local catalog of digital content. The digital content may include videogames, movies, music, applications, etc., which may be purchased or rented from the content provider through local digital content system 102. Digital content cache 104 may have a predetermined storage capacity for digital content. The predetermined storage capacity defines a local capacity for digital content, i.e., an amount of digital content that may be stored at digital content cache 104 and local digital content system 102.

Digital content determination module 106 may determine the local catalog of digital content based on the global catalog of digital content and a local consumption pattern for digital content. Digital content determination module 106 may identify the local consumption pattern for digital content by analyzing transactions at the location to determine a frequency of transactions associated with particular digital content in a particular time range. For example, digital content determination module 106 may record a transaction time for each transaction for particular digital content (e.g., the times that digital content is browsed, rented or bought) and determine a probability of future transactions for related digital content based on a number of transactions, the transaction times, and/or information associated with the particular digital content (e.g., a release date, rating, language, genre, etc., of a movie). The time range may be a fixed period or alternatively a relative period, such as a range from a preceding month to a current time. Digital content determination module 106 may determine similarities in frequently selected digital content, e.g., foreign language comedies are frequently selected at a particular location.

Digital content determination module 106 may compare digital content for which transactions frequently occur with digital content available in the global catalog of digital content to determine digital content that exceeds a threshold of being selected by users at the location through user devices 210. The selection of the digital content may include browsing, rental or purchase of the digital content. For example, digital content determination module 106 may identify digital content that has similar associated information, such as a particular language and genre (e.g., French comedies), which is purchased or rented (at a number of times exceeding the threshold of being selected) at the location. Digital content determination module 106 may identify additional digital content with similar associated information in the global catalog of digital content. Digital content determination module 106 may add this additional digital content to the local catalog of digital content. The threshold of being selected may be determined by content management module 108 described below.

According to one embodiment, digital content determination module 106 may determine the local catalog of digital content based on the most popular digital content that is received through LAN 202 by user devices 210. For instance, digital content determination module 106 may determine that particular digital content is to be added to the local catalog of digital content and stored at the location based on a threshold number of times that the digital content is accessed at the location.

Content management module 108 may receive/download digital content from global digital content system 120 based on the local catalog of digital content. For example, content management module 108 may download digital content corresponding to catalog entries that may have been added to a local catalog of digital content. If new entries are added to the local catalog of digital content from the global catalog of digital content, content management module 108 may download digital content corresponding to the new entries.

Content management module 108 may also enforce content management rules for digital content cache 104. For example, content management module 108 may retain digital content for a time based on a number of factors, such as the local capacity for digital content (e.g., a capacity of digital content cache 104), the size of a particular digital content (e.g., a size in bits/bytes), availability of updated editions of digital content, recent consumer activity with regard to the digital content (e.g., recent browsing, renting or buying of the digital content), etc. Content management module 108 may also determine the threshold of content being selected, to manage the local capacity for digital content. The threshold may be a value, such as a number of transactions associated with the digital content, which may be manipulated to limit the local catalog of digital content. For example, content management module 108 may determine a retention time for the digital content based on a particular number of times that the content is selected. Content management module 108 may remove entries that are not selected after a period exceeding the retention time has passed from the local catalog of digital content. Content management module 108 may delete digital content that is removed from the local catalog of digital content. Content management module 108 may also supply these thresholds to digital content determination module 106 to be used in determining additional entries for the local catalog of digital content.

According to an embodiment, content management module 108 may determine a threshold for further entries (i.e., additional digital content) for the local catalog of digital content based on ratings of digital content received at the location. The digital content may be ranked based on recommendations (e.g., a five star rating system) received from customers at the location. Alternatively, content management module 108 may receive ratings, rankings or requests associated with the location for particular digital content that is not currently included in the local catalog of digital content. Content management module 108 may determine the threshold for adding digital content to the local catalog of digital content based on the ratings, rankings or requests.

Content management module 108 may also determine the threshold for adding digital content to the local catalog of digital content based on the local capacity for digital content. For example, content management module 108 lower the threshold and correspondingly increase the local catalog of digital content based on a increase in the local capacity for digital content (e.g., a capacity of digital content cache 104 is increased by adding additional storage devices).

LAN management module 110 may provide digital content to devices, such as user devices in particular locations (e.g., local digital content system 102 may provide a localized retail user interface for digital content, for instance, as described with respect to FIG. 2A below). Alternatively, local digital content system 102 may provide digital content to provider devices in particular service areas (e.g., local digital content system 102 may be implemented as an intermediary system for digital content, for instance, as described with respect to FIG. 2C below). LAN management module 110 may provide the digital content using a LAN, such as a wireless LAN (e.g., a Wi-Fi provided at store, supermarket, gas station or other public location) (FIG. 2A) or a wired network.

FIG. 2A is a diagram of an exemplary network 200 in which systems and/or methods described herein may be implemented. As illustrated, network 200 may include local digital content system 102, network interface 204 and a user device 210. The configuration of components of network 200 illustrated in FIG. 2A is for illustrative purposes. Other configurations may be implemented. Therefore, network 200 may include additional, fewer and/or different components than those depicted in FIG. 2A.

FIG. 2A shows an implementation of local digital content system 102 as a retail device for digital content. LAN management module 110, in particular, may manage interaction with user devices 210 to provide digital content through a localized retail user interface (UI). The localized retail UI is a UI, provided at user devices 210, that includes information, such as the local catalog of digital content, and provides digital content which is associated with a particular location. For example, the localized retail UI may be represented as a virtual Kiosk of digital content and may be offered at locations served by LAN 202, e.g., gas stations, airports, restaurants, grocery stores, theaters, sports arena, public locations, etc. The localized retail UI may include information that is specific to, or adapted for, the location (e.g., features and information may be provided based on demographics and digital content usage patterns of the users at the location, such as language preferences etc.).

LAN management module 110 may establish a LAN 202 through which user device 210 may connect to the localized retail UI. LAN 202 may be a substantially high speed network.

In one implementation, LAN 202 may be a wireless LAN. Alternatively, LAN 202 may be a LAN that provides a physical interface to user devices 210, such as a LAN that has Ethernet connections. User device 210 may connect to LAN 202 through network interface 204, which may be a digital interface (corresponding to a wireless LAN) or a physical interface (e.g., through an Ethernet connection).

User device 210 may include a device that is capable of receiving and, in some instances, playing digital content (e.g., a live video feed). For example, user device 210 may include a mobile device, such as a tablet, television (TV), personal computer (PC), video game console, or mobile telephone (e.g., a BlackBerry, Palm, Android, or iPhone operating system (iOS) handsets), etc.

User device 210 may connect to LAN 202, for instance, using near field communication (NFC) pairing, Wi-Fi login, etc. For example, if a user brings user device 210 within proximity of LAN 202, LAN management module 110 may initiate the establishment of a connection with user device 210. LAN management module 110 may automatically conduct an authentication and authorization process (e.g., a security handshake protocol) and provide the localized retail UI to user device 210. User devices 210 may rent/purchase digital content through LAN 202 and receive the digital content (e.g., LAN management module 110 may stream/upload the digital content to user device 210).

LAN management module 110 may send a location based digital content message to user device 210. The location based digital content message may include content based on a location of user device 210 or based on previous transactions in instances that the user has previously subscribed to a service provided through the localized retail UI. Alternatively, LAN management module 110 may provide a location based digital content message that includes a subscription offer from a digital content provider.

FIG. 2B is a diagram showing an example of one embodiment of a location based digital content message 216 provided to user device 210 from LAN management module 110. FIG. 2B shows a user device 210 with a display 214. User device 210 displays a location based digital content message 216 in a dialog box 106 that may prompt the user “Welcome to the digital rental kiosk. Do you want to browse our catalog of titles?” The catalog of titles may include the local catalog of digital content and the global catalog of digital content. Location based digital content message 216 may also include a prompt to activate browsing of the catalog of titles via the localized retail UI. For example, user device 210 displays one or more options 218 for the user. When the user selects “yes”, display 214 may show the localized retail UI.

According to one embodiment, LAN management module 110 may provide access to digital content, listed in the local catalog of digital content that may be cached on digital content cache 104, through the localized retail UI. The digital content may include content that is provided by a service provider or content from business partners of the service provider. LAN management module 110 may provide digital content based on subscriptions to a monthly package or usage based fee. Further, the charges associated with the digital content may be advertisement supported. For example, LAN management module 110 may provide the digital content based on an advertisement supported package in which partners may pay for data usage charges of LAN 202, and, in some instances, the digital content.

According to another embodiment, if a user of a user device 210 is not a subscriber to a service plan, LAN management module 110 may send a location based digital content message 216 that prompts (“invites”) the user to subscribe to a service plan. The message may also include a catalog of digital content from the service provider and business partners of the service provider.

According to another embodiment, in addition to content listed in the local catalog of digital content, LAN management module 110 may provide access to digital content listed in the global catalog of digital content. For example, digital content message 216 provided to user device 210 from LAN management module 110 may indicate that additional digital content, which is not currently included in the local catalog of digital content, may be selected from the digital rental kiosk (e.g., content to be downloaded from the global catalog of digital content may be designated as premium or specialty content). Digital content message 216 may indicate that digital content that may be downloaded from the global catalog of digital content at a slower download speed, when compared to digital content downloaded from the local catalog of digital content. Digital content message 216 may provide an estimate of a download time for each digital item. Digital content message 216 may also include an estimate of additional data charges for digital content downloaded from the global catalog of digital content.

FIG. 2C is a diagram of an exemplary network 250 in which systems and/or methods described herein may be implemented. As illustrated, network 250 may include local digital content system 102 and provider devices 252a-252n. The configuration of components of system 106 illustrated in FIG. 2C is for illustrative purposes. Other configurations may be implemented. Therefore, network 200 may include additional, fewer and/or different components than those depicted in FIG. 2C.

FIG. 2C shows an implementation of local digital content system 102 as a retail device for digital content. LAN management module 110, in particular, may provide digital content associated with a particular location to provider devices, such as provider devices 252a-252n. In this implementation, local digital content system 102 may be implemented in a central office of the content provider to provide localized digital content for a geographic region served by the content provider. Local digital content system 102 may be close to provider devices 252a-252n to minimize bandwidth requirements and network delays for the digital content (e.g., local digital content system 102 may be few network hops away from provider devices 252a-252n).

Local digital content system 102 may be implemented to reduce bandwidth usage in network 100. For example, digital content determination module 106 may analyze network traffic to determine frequently accessed high bandwidth digital content in a particular location or region of network 100. Digital content determination module 106 may store the frequently accessed high bandwidth digital content in digital content cache 104. The frequently accessed high bandwidth digital content may be added to the local catalog of digital content. Further requests for the particular content may be routed to LAN management module 110. LAN management module 110 may provide the locally stored digital content to requesting devices within a LAN managed by LAN management module 110.

According to one implementation, digital content determination module 106 may identify digital content that has a relatively high probability of being accessed by a user based on the previously selected content and the global catalog of digital content. For example, digital content determination module 106 may receive a global catalog of digital content (e.g., digital content that is available through network 100). Content management module 108 may download digital content that has a relatively high probability of being selected (e.g., based on correlations between the downloaded content and frequently accessed digital content, such as a newer edition of a video game, a new episode of a television program, etc.) to digital content cache 104. LAN management module 110 may provide the digital content, thereby reducing latency for requesting devices and decreasing a total network traffic in network 100.

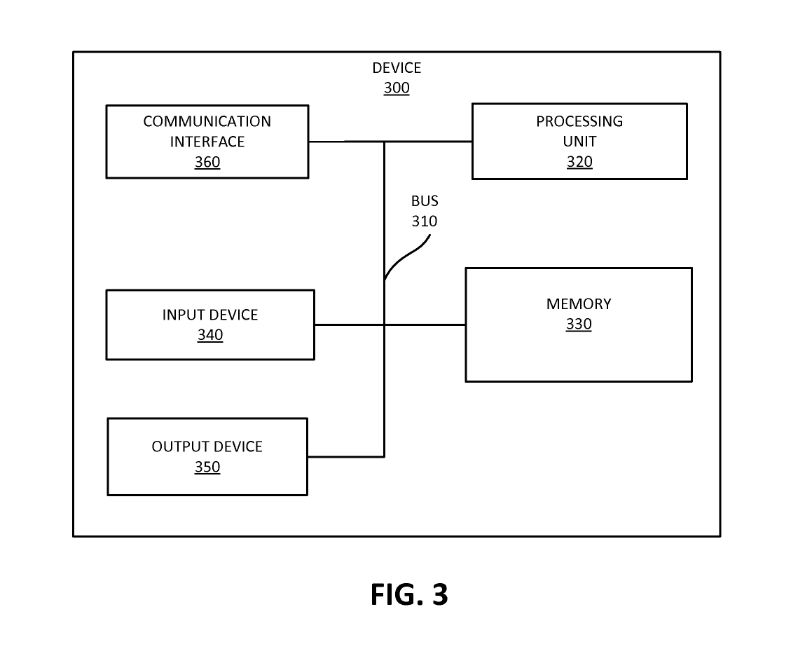

FIG. 3 is a diagram of exemplary components of a device 300. User device 210, provider device 252, local digital content system 102 or global digital content system 120 may include one or more devices 300. As shown in FIG. 3, device 300 may include a bus 310, a processing unit 320, a memory 330, an input device 340, an output device 350, and a communication interface 360. Bus 310 may permit communication among the components of device 300.

Processing unit 320 may include any type of processor or microprocessor that interprets and executes instructions. In other implementations, processing unit 320 may be implemented as or include an application specific integrated circuit (ASIC), field programmable gate array (FPGA), or the like.

Memory 330 may include a random access memory (RAM) or another type of dynamic storage device that stores information and instructions for execution by processing unit 320, a read only memory (ROM) or another type of static storage device that stores static information and instructions for processing unit 320, and/or some other type of magnetic or optical recording medium and its corresponding drive for storing information and/or instructions.

Input device 340 may include a device that permits an operator to input information to device 300, such as a keyboard, a keypad, a mouse, a pen, a microphone, a remote, etc. Output device 350 may include a device that outputs information to the operator, such as a display, a speaker, etc.

In an exemplary implementation, device 300 may perform operations in response to processing unit 320 executing sequences of instructions contained in a computer-readable medium, such as memory 330. A computer-readable medium may be defined as a physical or logical memory device. The software instructions may be read into memory 330 from another computer-readable medium (e.g., a hard disk drive (HDD), solid state drive (SSD), etc.), or from another device via communication interface 360. Alternatively, hard-wired circuitry may be used in place of or in combination with software instructions to implement processes consistent with the implementations described herein. Thus, implementations described herein are not limited to any specific combination of hardware circuitry and software.

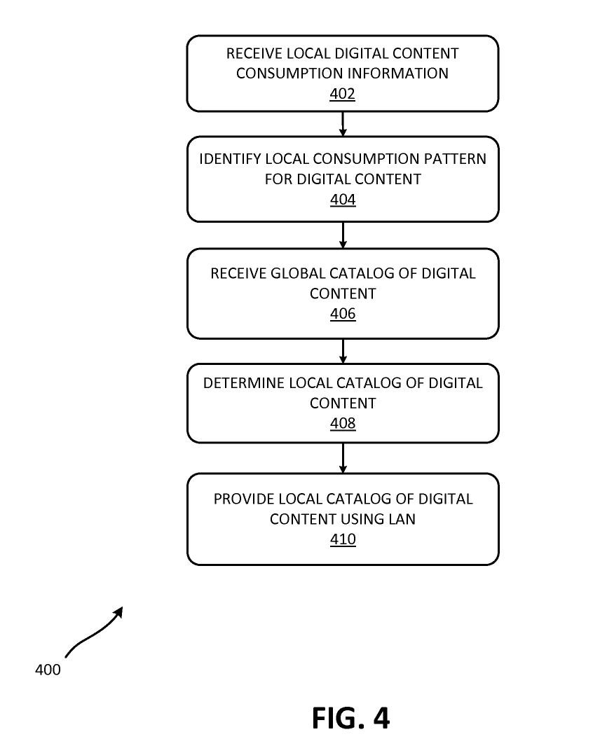

FIG. 4 is a flowchart of an exemplary process 400 for determining digital content to be provided at a location. Process 400 may execute in local digital content system 102. It should be apparent that the process discussed below with respect to FIG. 4 represents a generalized illustration and that other elements may be added or existing elements may be removed, modified or rearranged without departing from the scope of process 400.

At block 402, digital content determination module 106 may receive local digital content consumption information, i.e., information regarding local consumption of digital content. For example, digital content determination module 106 may receive information after each transaction for digital content. Digital content determination module 106 may also aggregate information based on transaction types, particular digital content, etc.

Digital content determination module 106 may identify a local consumption pattern for digital content (block 404). For example, digital content determination module 106 may identify types of digital content that are frequently purchased, rented or browsed at particular locations. Digital content determination module 106 may also identify frequently accessed high bandwidth digital content.

At block 406, digital content determination module 106 may receive a global catalog of digital content. For example, digital content determination module 106 may receive a global catalog of digital content from global digital content system 120. Alternatively, digital content determination module 106 may receive updates to the global catalog of digital content at particular instances, such as predetermined periods (e.g., digital content determination module 106 may receive updates at six hour intervals).

At block 408, digital content determination module 106 may determine a local catalog of digital content based on the identified consumption pattern and the global catalog of digital content. For example, digital content determination module 106 may select content from the global catalog of digital content based on, for example, actors, directors, etc., subjects (e.g., genres, sports, documentaries, etc.), rankings (e.g., ratings, reviews, top grossing box office movies), recent digital releases, prevalent languages and culture in a location, similar applications and video games, etc.

At block 410, LAN management module 110 may provide access to the local catalog of digital content. LAN management module 110 may access the local catalog of digital content determined by digital content determination module 106 and may provide the local catalog of digital content using LAN 202 to a user device 210. For example, user device 210 may access the digital content as described with respect to process 500 and the information pertaining to the transaction may be added to the information regarding local consumption of digital content and used to update the local catalog of digital content.

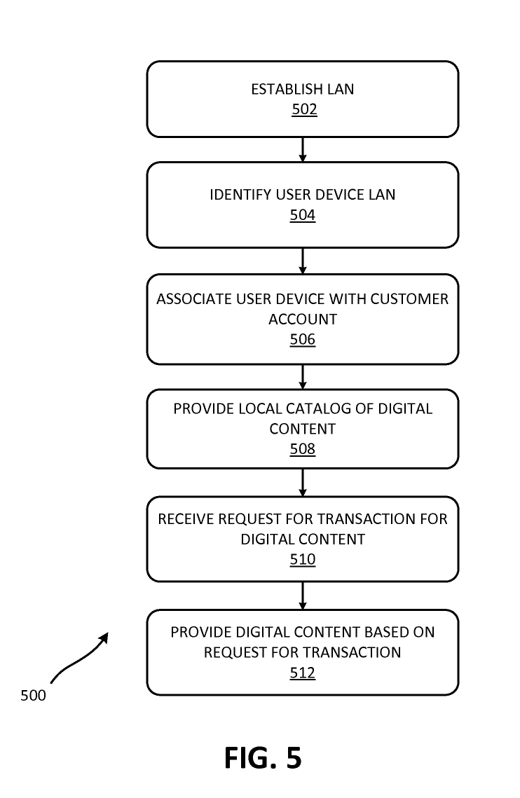

FIG. 5 is a flowchart of an exemplary process 500 for providing a local catalog of digital content to a user device 210. Process 500 may execute in local digital content system 102, for example, in LAN management module 110. It should be apparent that the process discussed below with respect to FIG. 5 represents a generalized illustration and that other elements may be added or existing elements may be removed, modified or rearranged without departing from the scope of process 500.

At block 502, LAN management module 110 may establish a LAN 202. LAN 202 may be a wireless LAN. Alternatively, LAN 202 may be a wired LAN. LAN management module 110 may establish LAN 202 in a location, based on consumer or user traffic, such as a mall, a gas station, etc.

At block 504, LAN management module 110 may identify user device 210. For example, LAN management module 110 may identify and authenticate user device 210 in LAN 202 by NFC.

At block 506, LAN management module 110 may associate the user at user device 210 with a customer account. LAN management module 110 may determine an associated customer account for user device 210 based on information stored on user device 210 (e.g., passcodes stored on user device 210 during the previous registration of user device 210).

At block 508, LAN management module 110 may provide access to the local catalog of digital content. For example, LAN management module 110 may provide a localized retail UI through which a user of user device 210 may browse and select content. The user may browse the local catalog of digital content using a GUI on user device 210 and the localized retail UI provided by LAN management module 110.

At block 510, LAN management module 110 may receive a request for a transaction for particular digital content from user device 210. For example, the user may purchase or rent the particular digital content. Further, the user may retrieve preview features during browsing of the local catalog of digital content (e.g., LAN management module 110 may record a number of times that particular content is browsed, to be used by content management module 108 in determining retention times for the particular digital content, etc., as described with respect to FIG. 2A above). LAN management module 110 may receive these requests for transactions from user device 210 and provide the digital content (512). LAN management module 110 may also contact supporting systems, for example billing server 124 to complete transactions with user device 210.

The foregoing description of exemplary implementations provides illustration and description, but is not intended to be exhaustive or to limit the embodiments described herein to the precise form disclosed. Modifications and variations are possible in light of the above teachings or may be acquired from practice of the embodiments.

For example, while series of blocks have been described with respect to FIGS. 4 and 5, the order of the blocks may be modified in other implementations. Further, non-dependent blocks may be performed in parallel.

It will be apparent that different aspects of the description provided above may be implemented in many different forms of software, firmware, and hardware in the implementations illustrated in the figures. The actual software code or specialized control hardware used to implement these aspects is not limiting of the invention. Thus, the operation and behavior of these aspects were described without reference to the specific software code--it being understood that software and control hardware can be designed to implement these aspects based on the description herein.

Although the implementations described above mainly refer to a telecommunications service provider providing applications to a customer, in other implementations, other types of customer-provider relationships may be supported.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

No element, act, or instruction used in the description of the present application should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

What is claimed is:

1. A computer-implemented method comprising:
receiving local digital content consumption information associated with a location;
identifying a local consumption pattern for digital content based on the local digital content consumption information;
receiving a global catalog of digital content;
determining a local catalog of digital content based on the local consumption pattern for digital content and the global catalog of digital content; and
providing the local catalog of digital content using a local area network (LAN).

2. The computer-implemented method of claim 1, wherein providing the local catalog of digital content using the LAN further comprises:
identifying a user device in the LAN;
associating the user device with a customer account;
providing access to the local catalog of digital content through a localized retail user interface;
receiving a request for a transaction for digital content from the user device; and
providing the digital content based on the request for the transaction.

3. The computer-implemented method of claim 2, wherein providing the digital content based on the request for the transaction further comprises:
providing the digital content based on one or more of a monthly subscription package, an advertisement supported package, or a usage based fee.

4. The computer-implemented method of claim 1, wherein providing the local catalog of digital content using the LAN further comprises:
providing the local catalog of digital content to one or more of a user device, a network routing device, or a retail interface device.

5. The computer-implemented method of claim 1, wherein determining the local catalog of digital content further comprises:
determining the local catalog of digital content based on a local storage capacity for the digital content.

6. The computer-implemented method of claim 1, wherein determining the local catalog of digital content further comprises:
identifying digital content for which transactions frequently occur;
comparing the identified digital content for which transactions frequently occur with digital content listed in the global catalog of digital content to identify digital content that exceeds a threshold of being selected at the location; and
listing the digital content that exceeds the threshold of being selected at the location in the local catalog of digital content.

7. The computer-implemented method of claim 1, wherein determining the local catalog of digital content further comprises:
receiving one or more of ratings, rankings, or requests for digital content from user devices associated with the location; and
determining the local catalog of digital content based on the one or more of the ratings, rankings, or requests.

8. The computer-implemented method of claim 1, wherein identifying the local consumption pattern for digital content comprises:
identifying a frequency of transactions associated with particular digital content in a particular time period.

9. The computer-implemented method of claim 1, wherein determining the local catalog of digital content further comprises:
analyzing network traffic in a network to determine frequently occurring high bandwidth digital content; and
adding the frequently occurring high bandwidth digital content to the local catalog of digital content.

10. The computer-implemented method of claim 1, wherein the digital content includes one or more of movies, applications, video games or music.

11. A device, comprising:
a memory to store a plurality of instructions; and
a processor configured to execute instructions in the memory to:
receive local digital content consumption information associated with a location;
identify a local consumption pattern for digital content based on the local digital content consumption information;
receive a global catalog of digital content;
determine a local catalog of digital content based on the local consumption pattern for digital content and the global catalog of digital content; and
provide the local catalog of digital content using a local area network (LAN).

12. The device of claim 11, wherein, when providing the local catalog of digital content using the LAN, the processor is further configured to:
identify a user device in the LAN;
associate the user device with a customer account;
provide access to the local catalog of digital content through a localized retail user interface;
receive a request for a transaction for digital content from the user device; and
provide the digital content based on the request for the transaction.

13. The device of claim 11, wherein the processor is further configured to provide the local catalog of digital content based on one or more of a monthly subscription package, an advertisement supported package, or a usage based fee.

14. The device of claim 13, wherein, when determining the local catalog of digital content, the processor is further configured to:
determine the local catalog of digital content based on a local storage capacity for the digital content.

15. The device of claim 12, wherein, when determining the local catalog of digital content, the processor is further configured to:
identify digital content for which transactions frequently occur;
compare the identified digital content for which transactions frequently occur with digital content listed in the global catalog of digital content to identified digital content that exceeds a threshold of being selected at the location; and
listing the digital content that exceeds the threshold of being selected at the location in the local catalog of digital content.

16. The device of claim 15, wherein, when determining the local catalog of digital content, the processor is further configured to:
receive one or more of ratings, rankings, or requests for digital content from user devices associated with the location; and
determine the local catalog of digital content based on the one or more of the ratings, rankings, or requests.

17. The device of claim 12, wherein, when determining the local catalog of digital content, the processor is configured to:
analyze network traffic in a network to determine frequently accessed high bandwidth digital content; and
list the frequently accessed high bandwidth digital content in the local catalog of digital content.

18. A computer-readable medium including instructions to be executed by a processor, the instructions including one or more instructions, when executed by the processor, for causing the processor to:
receive local digital content consumption information associated with a location;
identify a local consumption pattern for digital content based on the local digital content consumption information;
receive a global catalog of digital content;
determine a local catalog of digital content based on the local consumption pattern for digital content and the global catalog of digital content ; and
provide the local catalog of digital content using a local area network (LAN).

19. The computer-readable medium of claim 19, wherein, when providing the local catalog of digital content using the LAN, the one or more instructions further includes instructions to:
identify a user device in the LAN;
associate the user device with a customer account;
provide access to the local catalog of digital content through a localized retail user interface;
receive a request for a transaction for digital content from the user device; and
provide the digital content based on the request for the transaction.

20. The computer-readable medium of claim 18, wherein, when determining the local catalog of digital content, the one or more instructions further includes instructions to:
analyze network traffic in a network to determine frequently accessed high bandwidth digital content; and
list the frequently accessed high bandwidth digital content in the local catalog of digital content.
